(19) United States
(12) Patent Application Publication
(10) Pub. No.: US 2019/0174233 A1
(43) Pub. Date: Jun. 6, 2019

(54) BONE CONDUCTION SPEAKER UNIT

(71) Applicant: TEMCO JAPAN CO., LTD., Tokyo (JP)

(72) Inventor: Mikio FUKUDA, Tokyo (JP)

(73) Assignee: Temco Japan Co., Ltd., Tokyo (JP)

(21) Appl. No.: 16/322,206

(22) PCT Filed: Mar. 23, 2018
(86) PCT No.: PCT/JP2018/011692

§ 371 Date: Jan. 31, 2019

(30) Foreign Application Priority Data
Apr. 21, 2017 (JP) 2017-084744

(51) Int. Cl. H04R 9/06; H04R 9/02; H04R 1/02

(52) U.S. Cl. CPC H04R 9/06; H04R 9/025; H04R 2460/13; H04R 1/025; H04R 1/023

(57) ABSTRACT

Provided is a bone conduction speaker unit with which the possibility of adsorption of fine iron powder and dirt and dust, entrance of moisture, or the like, has been eliminated, and further the level of the sound leakage from the bone conduction speaker unit as a single element is satisfactorily low over a frequency range that is crucial for good sound transmission using a bone conduction speaker. The bone conduction speaker unit is of magnetic type, having a bone conduction speaker being housed in a unit casing the top of which is opened, with a contact plate for vibration transmission being disposed above a diaphragm of the bone conduction speaker, the top opening of the unit casing being blocked with an elastic membrane that is breathable.

### CROSS-REFERENCE TO RELATED APPLICATIONS

This application claims priority to PCT Application No. PCT/JP2018/011692, having a filing date of Mar. 23, 2018, based off of Japanese Application No. 2017-084744, having a filing date of Apr. 21, 2017, the entire contents of which are hereby incorporated by reference.

### FIELD OF TECHNOLOGY

The following relates to a bone conduction speaker unit, and more particularly, a bone conduction speaker unit with which a means for eliminating the possibility of adsorption of iron powder and dirt and dust, and entrance of moisture is added, the level of the sound leakage that will be generated in association with the means being satisfactorily low over a frequency range that is crucial for good sound transmission using a bone conduction speaker.

### BACKGROUND

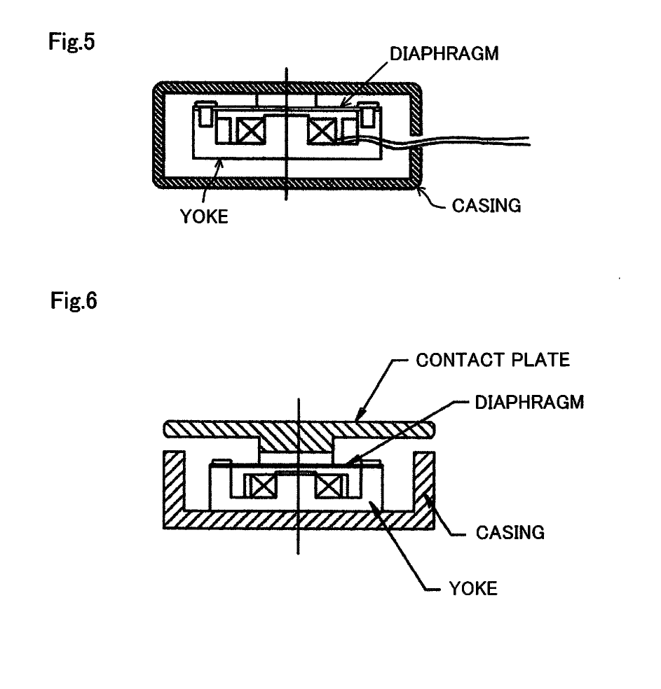

The basic method of using a bone conduction speaker is to use the bone conduction speaker as a speaker unit by mounting it to a small-sized casing, and when the bone conduction speaker is to be used as a speaker unit, two different types of configuration are available. The first type of configuration provides a structure in which, as shown in FIG. 5, a diaphragm part of the speaker unit is fixed to the inside of the speaker casing to cause the entire casing to be vibrated (for example, refer to Japanese Patent No. 3556168). This type of configuration provides an advantage that, at a frequency in the vicinity of the resonance frequency, which is determined by the spring property of the diaphragm and the weight of the yoke part, a higher output can be obtained, while it has a disadvantage of the entire output frequency range being narrower.

The second type of configuration provides a structure in which, as shown in FIG. 6, the yoke side of the bone conduction speaker is fixed to the casing, and above the diaphragm, there is disposed a contact plate part to transmit a vibration, the contact plate part being pressed against a human body to thereby transmit the vibration. (This type of bone conduction speaker unit has been disclosed in such documents as Japanese Patent No. 4369976, and Re-publication of PCT International Publication No. WO2014/097744.) Features of this type of configuration include that the frequency characteristics possessed by the speaker are reflected to the sound output as they are, and that, since the section that is mainly vibrated is the diaphragm part, the level of the sound leakage to the outside when in use is relatively low.

### SUMMARY

Generally, it is said that, with the bone conduction speaker, the level of sound leakage is low, however, the speaker itself is a vibrating element, and thus, so long as it is used in a conventional manner, it is difficult to reduce the sound leakage occurring in actual service to a satisfactorily low level. Detailed examination of the cause for sound leakage from a speaker unit as a single element shows that, with the above-mentioned first type of configuration, the speaker casing itself is vibrated, and thus the level of sound leakage depends on the size of the speaker casing and the intensity of the sound output.

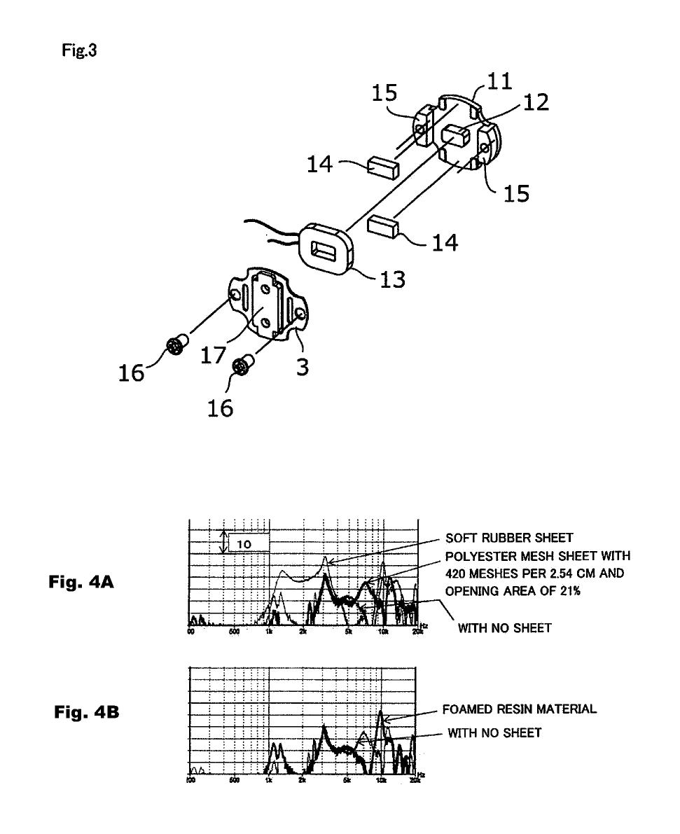

In addition, as a result of the later-described comparison test, it has been found that, with the second type of configuration, there is provided the lowest level of sound leakage over a frequency range that is crucial for good sound transmission using a bone conduction speaker when it takes a structure in which a space is held between the casing and the contact plate (diaphragm) (refer to the data for the sound leakage from the later-described unit 3 in FIGS. 4A and 4B). The structure of speaker unit that is shown in FIG. 6 can be said to be the simplest one as that of a speaker unit. However, since the speaker unit is formed of magnets, there is the possibility that fine iron powder and dirt and dust may be adsorbed thereto, but in spite thereof, the structure of speaker unit shown in FIG. 6 is provided with no measure against adsorption of fine iron powder and dirt and dust, entrance of moisture, and the like.

Then, embodiments of the present invention has been made to solve such a problem, and it is an object of embodiments of the present invention to provide a bone conduction speaker with which a means for eliminating the possibility of adsorption of iron powder and dirt and dust, and entrance of moisture is added, the level of the sound leakage that will be generated in association with the means being satisfactorily low over a frequency range that is crucial for good sound transmission using a bone conduction speaker.

The advantage is a magnetic type bone conduction speaker unit including a unit casing, the top face thereof being opened, a bone conduction speaker, being housed in said unit casing, a diaphragm, being provided in said bone conduction speaker, and a contact plate for transmitting vibration, being disposed above said diaphragm, the top face opening of said unit casing being blocked with an elastic membrane that is breathable.

In one embodiment, said elastic membrane has a water proofing property and a dustproof property, and in another embodiment, said elastic membrane is a nonwoven fabric or a mesh sheet.

The advantage is a magnetic type bone conduction speaker unit including a unit casing, the top face thereof being opened, a bone conduction speaker, being housed in said unit casing, a diaphragm, being provided in said bone conduction speaker, and a contact plate for transmitting vibration, being disposed above said diaphragm,

a foamed resin material that is breathable being disposed between the entire circumference of the top face of said unit casing and the back face of said contact plate, and with said foamed resin material, said unit casing being brought into a blocked state.

In one embodiment, said foamed resin material is a low-foaming, high-density, and high-resilience material that is breathable, having a continuous foaming structure, and that has been subjected to a water repellency providing treatment.

### Advantages

Embodiments of the invention is as described above, and in accordance with embodiments of the present invention, there is offered an advantage that, since the inside of the unit casing in which the bone conduction speaker is housed is blocked with an elastic membrane or a foamed resin material that is breathable, there is no possibility that the bone conduction speaker may be adversely affected by adsorption of iron powder and dirt and dust or entrance of moisture, and in addition, since the elastic membrane and the foamed resin material are breathable, an air conduction sound with a high intensity, in other words, a sound leakage at a high level that would be generated in the case where an unbreathable membrane, such as a soft rubber sheet, is used to cover the unit casing will not be generated over a frequency range that is crucial for good sound transmission using a bone conduction speaker.

### BRIEF DESCRIPTION

Some of the embodiments will be described in detail, with reference to the following figures, wherein like designations denote like members, wherein:

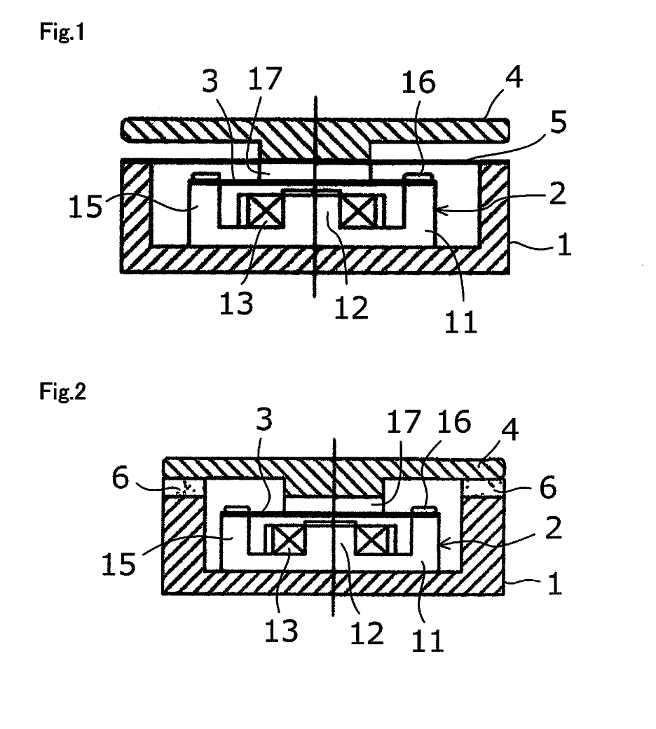

FIG. 1 is a longitudinal sectional view of a bone conduction speaker unit according to one embodiment of the present invention;

FIG. 2 is a longitudinal sectional view of a bone conduction speaker unit according to another embodiment of the present invention;

FIG. 3 is an exploded perspective view illustrating an example of configuration of the bone conduction speaker unit in accordance with embodiments of the present invention;

FIG. 4A is a graph illustrating the results of a comparison test for sound leakage that has been conducted in order to confirm the effectiveness of the bone conduction speaker unit in accordance with embodiments of the present invention;

FIG. 4B is a graph illustrating the results of a comparison test for sound leakage that has been conducted in order to confirm the effectiveness of the bone conduction speaker unit in accordance with embodiments of the present invention;

FIG. 5 is a longitudinal sectional view illustrating an example of conventional bone conduction speaker unit; and

FIG. 6 is a longitudinal sectional view illustrating another example of conventional bone conduction speaker unit.

### DETAILED DESCRIPTION

Hereinbelow, embodiments of the present invention will be explained with reference to the attached drawings. First, a bone conduction speaker unit according to a first embodiment of the present invention that is shown in FIG. 1 will be explained. As shown in that figure, the bone conduction speaker unit according to the first embodiment of the present invention is a bone conduction speaker unit of magnetic type with which a bone conduction speaker 2 is housed in a unit casing 1 the top of which is opened, with a contact plate 4 for vibration transmission being disposed above a diaphragm 3 of the bone conduction speaker 2.

The bone conduction speaker unit 2 is configured as shown in FIG. 3, for example, with a voice coil 13 being disposed so as to surround a center pole 12 provided in the central portion of a yoke 11, a pair of bar-like magnets 14, 14 being fixed to both sides of the voice coil 13, and a diaphragm 3 being disposed so as to cover the voice coil 13 and the magnets 14, 14. Both end parts of the diaphragm 3 are fastened with screws 16 to be fixed to the top face of side walls 15 that are erected on both end parts of the yoke 11. At that time, a gap is provided between the diaphragm 3 and the top face of the voice coil 13 (see FIG. 1).

The top opening of the unit casing 1 is blocked with an elastic membrane 5 that is breathable. The contact plate 4 in this case is fixed to a plate yoke 17 on the diaphragm 3 with an elastic membrane 5 being sandwiched therebetween. This elastic membrane 5 is specified to be breathable and also water-proofing and dust-proofing, and for example, a nonwoven fabric or a mesh sheet is used.

As the nonwoven fabric, a Himelon (registered tradename) nonwoven fabric with a thickness of 0.15 to 0.35 mm (HN603B to HN606B) that has been subjected to a water repellency providing treatment, manufactured by Ambic Co., Ltd., is well suited. Further, a SUNMAP (registered tradename) LC with a thickness of 0.1 mm, which is an ultrahigh-molecular-weight polyethylene porous film manufactured by NITTO DENKO CORPORATION, can also be used as the elastic membrane 5. Further, as the mesh sheet, a polyester net having 420 meshes per 2.54 cm and an opening area of 21% can be used.

From the view point of avoidance of adsorption of fine iron powder and dirt and dust, entrance of moisture, or the like, it can be said that an unbreathable elastic material, such as a soft rubber sheet, is more excellent as the elastic membrane than the above-mentioned materials, however, embodiments of the present invention is intended to provide a bone conduction speaker unit with which the possibility of adsorption of fine iron powder and dirt and dust, entrance of moisture, or the like, has been eliminated, and further the level of the sound leakage therefrom is satisfactorily low over a frequency range that is crucial for good sound transmission using a bone conduction speaker. From such intention of embodiments of the present invention, it is required that the elastic membrane 5 be breathable.

Next, a bone conduction speaker unit according to a second embodiment of the present invention will be explained. In this second embodiment, as shown in FIG. 2, in place of the elastic membrane 5 in the above-described first embodiment, a foamed resin material 6 that is breathable is disposed between the entire circumference of the top face of the unit casing 1 and the back face of the contact plate 4, and with such foamed resin material 6, the unit casing 1 is brought into a blocked state.

As the foamed resin material 6, a low-foaming, high-density, and high-resilience material that is breathable, having a continuous foaming structure, such as a urethane foam, and that has been subjected to a water repellency providing treatment is used. Such a material can be compressed to be interposed in place, with the flexibility thereof being utilized at the time of assembling.

In order to verify the effectiveness of embodiments of the present invention, a comparison test for sound leakage of air conduction sound was conducted. This test was conducted by preparing a bone conduction speaker unit in accordance with embodiments of the present invention, shown in FIG. 1, with which, as the elastic membrane 5, a breathable mesh sheet formed of a polyester net having 420 meshes per 2.54 cm and an opening area of 21% is provided in a tensioned state (to be referred to as a unit 1); a bone conduction speaker unit with which, in place of the elastic membrane 5, an unbreathable soft rubber sheet is provided in a tensioned state (to be referred to as a unit 2); and a bone conduction speaker unit with which no sheet is provided (to be referred to as a unit 3, which is the same as shown in FIG. 6), applying an input signal with a higher intensity to the respective units, and installing a microphone in a location 3 cm away from the unit to measure the intensity of the air conduction sound that has been leaked therefrom.

FIG. 4 gives graphs for comparing the results of the test conducted, and as stated above, the unit 3, with which no sheet is provided, gives the best result. By referring to FIG. 4 (A), it has been confirmed that, for the unit 1 in accordance with embodiments of the present invention, with which a breathable elastic membrane 5 is provided in a tensioned state, the level of sound leakage is low by 10 dB or more in the range of 1.5 kHz to 2.5 kHz, as compared to that for the unit 2, with which an unbreathable sheet is provided in a tensioned state. Since the frequency band of 1.5 kHz to 2.5 kHz mainly provides a voice band for female vocal, a sound leakage in this frequency band is easily recognizable to ears, and thus a difference of 10 dB or more in sound leakage level could be said to be noticeable as a result of the comparison test. Further, in the frequency band ranging from over 5 kHz to over 8 kHz, the level of sound leakage for the unit 1 is considerably higher than that for the unit 2, however, such considerably higher level of sound leakage for the unit 1 is not so high as to cause a feeling of sound leakage, thus presenting no problem. Also, a unit with which a foamed resin material 6 is disposed in place of the elastic membrane 5 gave similar results (see FIG. 4B).

In FIG. 4A, as described above, in the frequency band ranging from over 5 kHz to over 8 kHz, the level of sound leakage for the unit 1 is considerably higher than that for unit 2, however, in the case where the user is a person who is non-impaired in hearing, the user will listen to a sound with the speaker being disposed in the immediate vicinity of the ear, and thus, although the level of sound leakage for the unit 1 is “not so high as to cause a feeling of sound leakage”, but the air conduction sound in the high-frequency range is heard, being superposed on the bone conduction sound, thereby “the considerably higher level of sound leakage for unit 1” as mentioned above being served to improve the high-frequency characteristics of the unit 1.

With the bone conduction speaker unit in accordance with embodiments of the present invention, the inside of the unit casing 1 in which the bone conduction speaker 2 is housed is blocked with an elastic membrane 5 or a foamed resin material 6 that is breathable, whereby there is no possibility that the bone conduction speaker may be adversely affected by adsorption of iron powder and dirt and dust or entrance of moisture. In addition, since the elastic membrane 5 and the foamed resin material 6 are breathable; therefore, the bone conduction speaker unit in accordance with embodiments of the present invention is characterized in that, as compared to the bone conduction unit with which the unit casing 1 is covered with an unbreathable membrane, such as a soft rubber sheet, the sound leakage is generated at a satisfactorily low level over a frequency range that is crucial for good sound transmission using a bone conduction speaker, whereby the bone conduction speaker unit in accordance with embodiments of the present invention offers a great industrial applicability.

### DESCRIPTION OF SYMBOLS

Reference numeral 1 denotes a unit casing; 2 a bone conduction speaker; 3 a diaphragm; 4 a contact plate; 5 an elastic membrane; 6 a foamed resin material; 11 a yoke; 12 a center pole; 13 a voice coil; 14 a magnet; 15 a side wall; 16 a screw; and 17 a plate yoke.

Although the present invention has been disclosed in the form of preferred embodiments and variations thereon, it will be understood that numerous additional modifications and variations could be made thereto without departing from the scope of the invention.

For the sake of clarity, it is to be understood that the use of ‘a’ or ‘an’ throughout this application does not exclude a plurality, and ‘comprising’ does not exclude other steps or elements.

1. A magnetic type bone conduction speaker unit comprising:
a unit casing, the top face thereof being opened, a bone conduction speaker, being housed in said unit casing, a diaphragm, being provided in said bone conduction speaker, and a contact plate for transmitting vibration, being disposed above said diaphragm,
the top face opening of said unit casing being blocked with an elastic membrane that is breathable.

2. The bone conduction speaker unit according to claim 1, wherein said elastic membrane has a water proofing property and a dustproof property.

3. The bone conduction speaker unit according to claim 1, wherein said elastic membrane is a nonwoven fabric or a mesh sheet.

4. A magnetic type bone conduction speaker unit comprising a unit casing, the top face thereof being opened, a bone conduction speaker, being housed in said unit casing, a diaphragm, being provided in said bone conduction speaker, and a contact plate for transmitting vibration, being disposed above said diaphragm,
a foamed resin material that is breathable being disposed between the entire circumference of the top face of said unit casing and the back face of said contact plate, and with said foamed resin material, said unit casing being brought into a blocked state.

5. The bone conduction speaker unit according to claim 4, wherein said foamed resin material is a low-foaming, high-density, and high-resilience material that is breathable, having a continuous foaming structure, and that has been subjected to a water repellency providing treatment.
